(19) United States
(12) Patent Application Publication
(10) Pub. No.: US 2008/0294957 A1
(43) Pub. Date: Nov. 27, 2008

(54) Communication Apparatus

(75) Inventors: Yee Chyan Tan, Kuala Lumpur (MY); Ming Hong Toong, Selangor (MY)

Correspondence Address: FISH & RICHARDSON P.C., P.O BOX 1022, Minneapolis, MN, 55440-1022, US

(73) Assignee: OYL RESEARCH AND DEVELOPMENT CENTRE SDN. BHD., Selangor (MY)

(21) Appl. No.: 11/970,791

(22) Filed: Jan. 8, 2008

(30) Foreign Application Priority Data
Jan. 8, 2007 (MY) PI 20070019

(51) Int. Cl. G06F 11/07

(52) U.S. Cl. 714/746

(57) ABSTRACT

A communication apparatus for converting signal between differential interchange circuit and multiple devices having input and output terminals comprising:
a timer for detecting logic level at idle state;
a flip-flop having at least one output terminals for switching a signal from one to the other by means of an external signal; and
at least one or more of logic gates for inverting said external signal from said circuit.

### FIELD OF THE INVENTION

The present invention relates to a communication apparatus for connecting between multiple devices and differential interchange circuit such as RS 485.

### BACKGROUND ART

Interchange circuits such as RS 485 having signals being represented by a pair of lines as input/output terminals (A and B). These signals have different polarity and the receiver will need to determine the logic level by sensing the voltage difference between these terminals. This configuration has the advantage of attenuating the common mode noise since any induced noise or ground differentials will appear as common mode signals to the receiver.

However, when the terminals are connected wrongly, the signals at the receiver will be inverted as disclosed in CN 1649349A and U.S. Pat. No. 5,956,523. The multiple devices system is unable to interpret the inverted signals received.

It is an object of the present invention to provide a connection between multiple devices and differential interchange circuit such as RS 485.

### SUMMARY OF THE INVENTION

A communication apparatus for detecting the error in the signal and converting signal between differential interchange circuit and multiple devices having input and output terminals comprising:
a timer for resetting logic level;
a flip-flop having at least one output terminals for switching a signal from one to the other by means of an external signal; and
at least one or more of logic gates for inverting said external signal from said circuit.

A method for converting signal between multiple devices and differential interchange circuit comprising:
receiving signals from differential interchange circuit;
detecting logic level at the receiving input/output terminals of the communication apparatus;
resetting the logic level by the timer in the communication apparatus and generating a pulse from the timer output in the communication apparatus;
triggering the flip-flop in the communication apparatus and inverting the signals received and
interpreting the received signals and establishing communication with the connected devices.

### BRIEF DESCRIPTION OF THE DRAWINGS

The foregoing summary, as well as the following detailed description of preferred embodiments of the invention, will be better understood when read in conjunction with the appended drawings. For purpose of illustrating the invention, there are shown in the drawing embodiments, which are presently preferred. It should be understood, however, that the invention is not limited to the precise arrangements and instrumentalities shown.

FIG. 1 is a waveform if input/output terminals (A and B) are connected correctly of one embodiment of the present invention.

FIG. 2 is a waveform if input/output terminals (A and B) are connected wrongly of one embodiment of the present invention.

FIG. 3 is a schematic of the circuit connections of communication apparatus of one embodiment of the present invention.

FIG. 4 is waveforms at each respective pin when input/output terminals (A and B) are connected correctly with the connection of the communication apparatus of one embodiment of the present invention.

FIG. 5 is waveforms at each respective pin when input/output terminals (A and B) are connected wrongly with the connection of the communication apparatus of one embodiment of the present invention.

### DETAILED DESCRIPTION OF THE PREFERRED EMBODIMENT

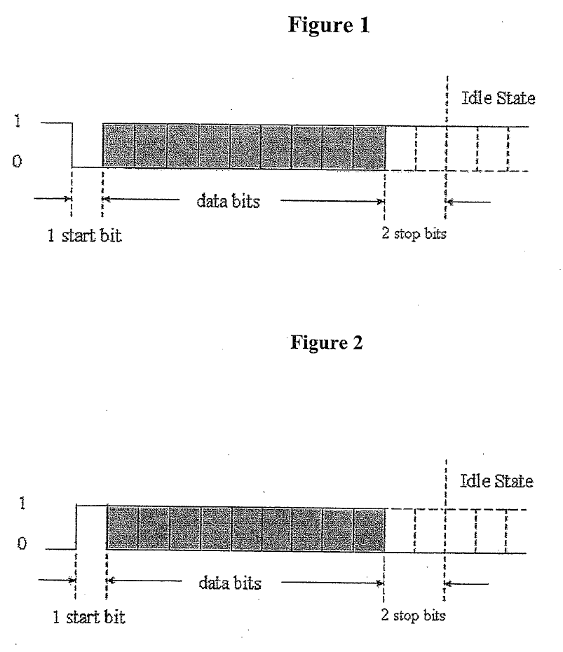

FIG. 1 shows a waveform if input/output terminals (A and B) are connected correctly of one embodiment of the present invention. FIG. 2 is a waveform if input/output terminals (A and B) are connected wrongly of one embodiment of the present invention. At idle state, the logic level at the receiving pin is high if input/output terminals (A and B) are connected correctly. If the input/output terminals (A and B) are wrongly connected the logic level at the receiving pin will be low at idle state. Without the auto-correcting circuitry in the communication apparatus of the present invention, multiple devices are not able to interpret the signals received directly from the differential interchange circuit such as RS 485 and etc if the input/output terminals are wrongly connected.

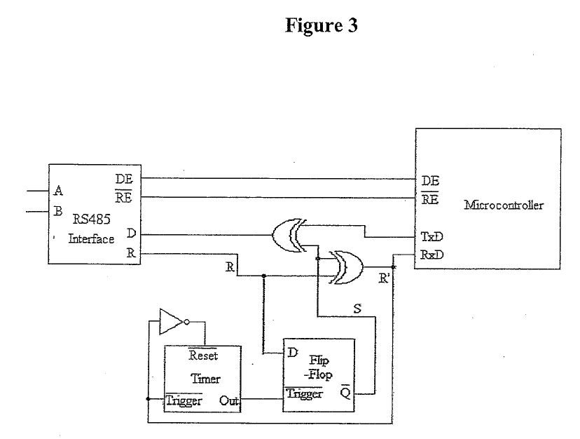

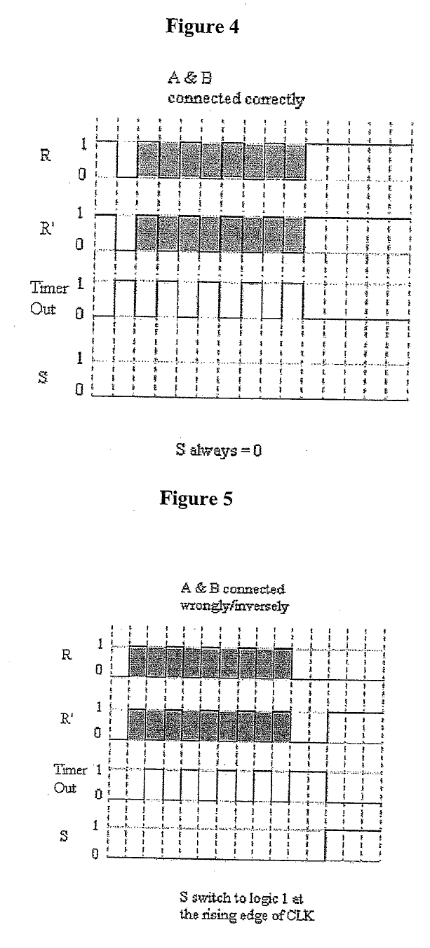

FIG. 3 shows a schematic of the circuit connections of communication apparatus of one embodiment of the present invention. A communication apparatus of the present invention comprises a timer, a flip-flop and XOR logic gates, which are formed into a circuit. This circuit will detect the logic level at the receiving pin, R. If the input/output terminals (A and B) are correctly connected, the signal level will be logic high at idle state. The timer will always reset in this case. When the timer resets, the negative going pulse from timer output triggers the flip-flop. The input D of the flip-flop is connected to R. In this case, R is always logic high when flip-flop is triggered. As a result, the output of the flip-flop will always be logic low as shown in FIG. 4. The output of the flip-flop is connected to the input of a pair of XOR gates (S). The logic level of R and R′ will be same when logic level at S is low.

In the case that input/output terminals (A and B) are wrongly connected, the signal level will be logic low at idle state. The timer will always reset at the presence of data signal but when line R returns to idle state, the timer will start counting. When the timer finished counting, timer output will becomes logic low and the negative going pulse at the timer output will trigger the flip-flop. When the flip-flop is triggered, the logic at R is low, causing the output of the flip-flop to become logic high. The output of the flip-flop is connected to the input of a pair of XOR gates (S). The logic level of R and R′ will be inverted when logic level at S is high. Inverting the signal at R′ makes the signal received by the microcontroller becomes logic high at idle state as shown in FIG. 5. Therefore, the system is able to interpret the received signals and establish communications between devices.

Although the present invention has been described in relation to particular embodiments thereof, many other variations and modifications and other uses will become apparent to those skilled in the art. Therefore, the present invention should be limited not by the specific disclosure herein, but only by the appended claims.

1. A communication apparatus for detecting an error in a signal and converting the signal between a differential interchange circuit and multiple devices having input and output terminals comprising:
a timer for detecting a logic level at an idle state;
a flip-flop having at least one output terminal for switching a signal from one logic level to another logic level by means of an external signal; and
at least one or more logic gates for inverting said external signal from said circuit.

2. The communication apparatus as claims in claim 1, wherein one of said input terminals is connected directly to said flip-flop.

3. The communication apparatus as claims in claim 1, wherein said input terminals comprise a first input terminal and a second input terminal.

4. The communication apparatus as claimed in claim 3, wherein said logic level is high at the idle state when said input terminals are correctly connected.

5. The communication apparatus as claimed in claim 3, wherein said logic level is low at the idle state when said input terminals are wrongly connected.

6. The communication apparatus as claimed in claim 1, wherein said timer resets and generates a negative going pulse from a timer output when said input terminals are correctly connected.

7. The communication apparatus as claimed in claim 1, wherein said timer starts counting and generates a logic low signal with a negative going pulse from a timer output when said input terminals are wrongly connected.

8. The communication apparatus as claimed in claim 1, wherein said flip-flop is triggered by a negative going pulse from a timer output.

9. The communication apparatus as claimed in claim 1, wherein said logic gates are a pair of XOR gates.

10. The communication apparatus as claimed in claim 9, wherein an output of the flip-flop is connected to said XOR gates.

11. The communication apparatus as claimed in claim 9, wherein an output of the XOR gates is at logic low level at idle state when said input terminals are correctly connected.

12. The communication apparatus as claimed in claim 9, wherein an output of the XOR gates inverts the signal logic level to high at idle state when input terminals are wrongly connected so that the connected system will able to interpret the received signals and establish communications between the differential interchange circuit and the multiple devices.

13. A method for converting signal between multiple devices and a differential interchange circuit comprising:
receiving at a communication apparatus one or more signals from a differential interchange circuit;
detecting a logic level at one or more receiving input terminals of the communication apparatus;
resetting the logic level of a timer in the communication apparatus and generating a pulse from a timer output in the communication apparatus;
triggering a flip-flop in the communication apparatus and inverting the one or more signals received; and
interpreting the one or more signals and establishing communication with the connected devices.
